(19) United States
(12) Patent Application Publication
(10) Pub. No.: US 2001/0035428 A1
(43) Pub. Date: Nov. 1, 2001

(54) Viscous substance containing tube

(76) Inventor: Yuly Shipilevsky, Toronto (CA)

Correspondence Address: YULY SHIPILEVSKY, 40 FOUNTAINHEAD ROAD, APT. 404, TORONTO, ON, M3J 2V1, CA

(21) Appl. No.: 09/803,393

(22) Filed: Mar. 12, 2001

Related U.S. Application Data
(60) Provisional application No. 60/193,415, filed on Mar. 31, 2000.

(51) Int. Cl. B65D 35/00; B67D 3/00

(52) U.S. Cl. 222/92; 222/482; 222/481; 222/107; 222/330

(57) ABSTRACT

A viscous substance containing tube comprises more than one lid-covered outlets. These outlets can be implemented at each of two tube's end and can be implemented on the tube's surface, between two tube's ends. Each outlet is used to squeeze out of the tube the portions located in the vicinity of that outlet by applying a squeezing force on the surface in the vicinity of chosen outlet. The simplest embodiment of the tube comprises only two outlets—an outlet per each of tube's end.

### BACKGROUND OF THE INVENTION

This invention relates to a tube for containing the viscous substances such as toothpastes, creams, oils, etc.

A common implement for a tube for containing the viscous substances housed inside that tube is a tube including a lid-covered outlet located at one of two ends of the tube. When fingers apply a squeezing force on the tube, a portion of a viscous substance located in the outlet's adjacent zone, that portion is being squeezed out of the tube through that single outlet.

Prior tubes have had the following disadvantage. Prior tubes have included only one lid-covered outlet located at one of two ends of the tube and squeezing out of the tube the portions located in the peripheral zones opposite to that single outlet is inconvenient and inexpedient, especially in regard to the relatively “ong” tubes.

### BRIEF SUMMARY OF THE INVENTION

This invention is directed to a tube for containing the viscous substances such as toothpastes, creams, oils, etc. The object of the present invention is to provide a tube that allows to issue a convenient and easily implemented squeezing out of the tube the portions of the viscous substance notwithstanding where these portions are located inside the tube.

The tube includes more that one lid-covered outlets. These outlets can be implemented at each of two tube's end and can be implemented on the tube's surface, between two tube's ends. Each outlet is used to squeeze out of the tube the portions located in the vicinity of that outlet by applying a squeezing force on the tube's surface in the vicinity of chosen outlet.

The most simple embodiment of the tube includes only two outlets—an outlet per each of two tube's end.

### BRIEF DESCRIPTION OF THE SEVERAL VIEWS OF THE DRAWING

FIG. 1 is a plan view of the viscous substance containing tube of the invention used to contain a viscous substance that can be squeezed out of the tube trough more than one lid-covered outlets.

FIG. 2 is a side view of the viscous substance containing tube of the invention used to contain a viscous substance that can be squeezed out of the tube through more than one lid-covered outlets.

### DETAILED DESCRIPTION OF THE INVENTION

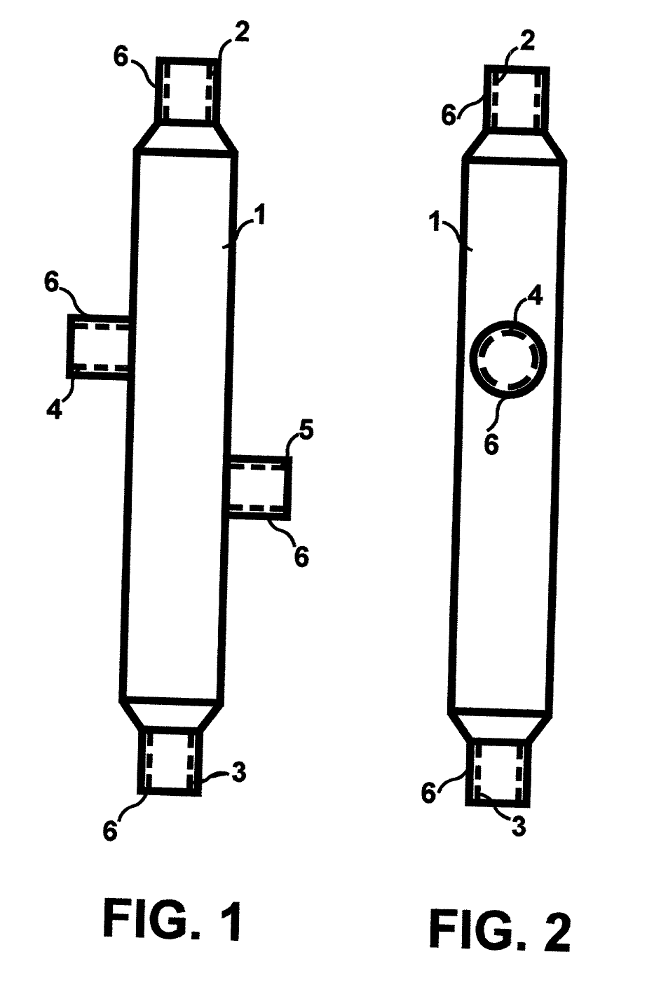

Reffering to FIG. 1 and FIG. 2 a tube for containing the viscous substance indicated generally at 1 is used to contain a viscous substances such as toothpastes, creams, oils, etc., housed inside tube 1 and said substance can be squeezed out of tube 1 through the several outlets 2, 3, 4, 5. Outlet 2 is located at one of two tube's 1 ends and outlet 3 is located at another end of tube 1. To provide even outlets' distribution, an additional outlet 4 can be implemented on one of two opposite sides of the surface of tube 1 between tube's ends 2 and 3 and an additional outlet 5 can be implemented on another side of the surface of tube 1 between tube's ends 2 and 3 as well. To squeeze out of tube 1 a viscous substance's portion located n the vicinity of each certain outlet of tube 1 it is necessary to remove or open lid 6, covering that outlet, make sure that other outlets of tube 1 are hermetically covered by their lids 6 and then apply a squeezing force on tube 1 in the vicinity of chosen tube's 1 outlet.

Each part of tube 1 made of the same materials as the appropriate part of the prior tubes.

While there has been shown and described a preferred embodiment of the viscous substance containing tube of this invention, it is understood that changes in structure, materials, sizes and shapes can be made by those skilled in the art without departing from the invention. The invention is defined in the following claims.

I claim:

1. A tube used to contain a viscous substance, said viscous substance housed inside said tube, wherein the improvement comprises more than one outlets, said viscous substance can be squeezed out of said tube through said outlets, each said outlet is covered by their own lid, said outlets can be implemented at each of two end of said tube and said outlets can be implemented on the surface of said tube between said two ends of said tube, said viscous substance's portions located in the vicinity of each certain said outlet, said portions can be squeezed out of said tube through said chosen outlet by applying a squeezing force on said tube in the vicinity of said chosen outlet whereas the appropriate said lid, covering said chosen outlet is preliminary removed or opened and another said outlets are hermetically covered by their said lids.
